(19) United States
(12) Patent Application Publication
(10) Pub. No.: US 2002/0175113 A1
(43) Pub. Date: Nov. 28, 2002

(54) Method and apparatus for sorting of chips

(76) Inventor: Hannu Tahkanen, Rauma (FI)

Correspondence Address: Benton S. Duffett, JR., BURNS, DOANE, SWECKER & MATHIS, L.L.P., P.O. Box 1404, Alexandria, VA, 22313-1404, US

(21) Appl. No.: 10/200,524

(22) Filed: Jul. 23, 2002

Related U.S. Application Data
(62) Division of application No. 09/701,048, filed on Dec. 28, 2000.
Application No. 09/701,048 is a 371 of international application No. PCT/FI99/00422, filed on May 17, 1999.

(30) Foreign Application Priority Data
May 22, 1998 (FI) 981136

(51) Int. Cl. B07C 5/00

(52) U.S. Cl. 209/639

(57) ABSTRACT

A method and an apparatus for the sorting of chips (3). The chips, which have kinetic energy, are separated from each other on the basis of the form or the length of their flight curve which depends on their air resistance. The kinetic energy of the chips is generated by a mechanical ejecting device (6) ejecting the chips or by means of a fan conveyor or by means of the wings of a blowing chipper.

This invention relates to a method and apparatus for the sorting of chips. The chips are sorted into accepted and rejected fractions by their specific weight and size.

Chip screening is used in the paper and pulp industry to produce geometrically uniform chips so that in the Kraft process, for example, as high a digestion degree as possible and as low a overcooking degree as possible can be obtained at the same time.

The chip sorting art includes different kinds of screens of which the best known is the flat screen. It is described, for example, in patent publication FI 79251. The screening surfaces of a flat screen are usually provided with round holes. The chip flow is divided into flows according to the diameters of the holes.

At the end of the 1980's it became popular in Finland to screen chips even by their thickness. One thickness-screening device is described in patent publication FI 89082. Thickness screening devices screen well and sort the chips accurately-into fractions of a desired type by the size and thickness of the chips. However, the screening result is good only if the thickness-screening device is composed of several parts. Such a composition naturally is expensive.

The objective of the current screening methods is to sort the chips on the basis of the geometric form of the chips. Flat screens perform the sorting mostly by the length of the chips, the thickness screening devices even by the thickness of the chips, which is of greater importance to the digestion of the chips. Nevertheless, the right chip length and thickness alone do not guarantee a good digestion result. Trees grown under different growing conditions and not of the same age have different specific weights. Besides, different parts of trees have different specific weights. Digesting chemicals penetrate less efficiently into dense wood, as a result of which chips of the same thickness as the rest of the chips but denser, are not digested in their entirety.

In patent publication U.S. Pat. No. 4,486,300, a grain sorting method is described. In it, grains are sorted by their density and by their air resistance. The grains are accelerated into a falling movement by means of an inclined slide plate and gravity. Together with the slide plate, a fan to give the grains kinetic energy can be used. A strong opposite horizontal current of air is directed toward the diagonally falling grain flow with the result that the densest and heaviest grains fall down earlier, while the lightest pieces fly farther.

The characteristic features of the present invention are set forth in claims 1, 9, 13 and 17.

In the method according to the invention, air resistance is applied to the sorting process. In the method the chips are sorted both by their size and by their density.

The invention and the details thereof will now be described in more detail with reference to the accompanying drawings wherein

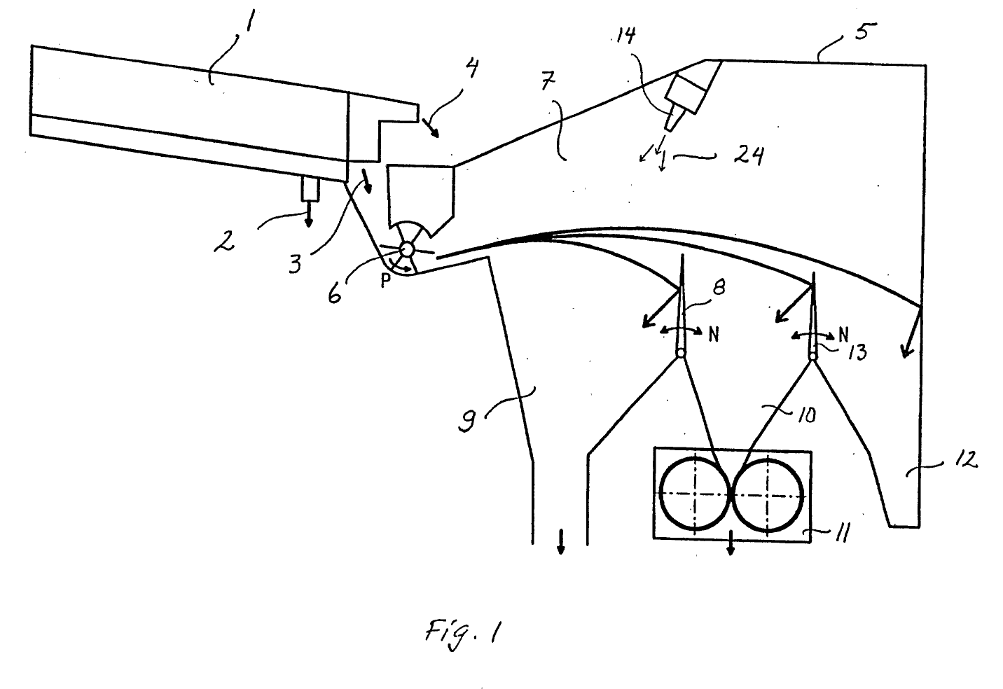

FIG. 1 shows a screening method according to the invention,

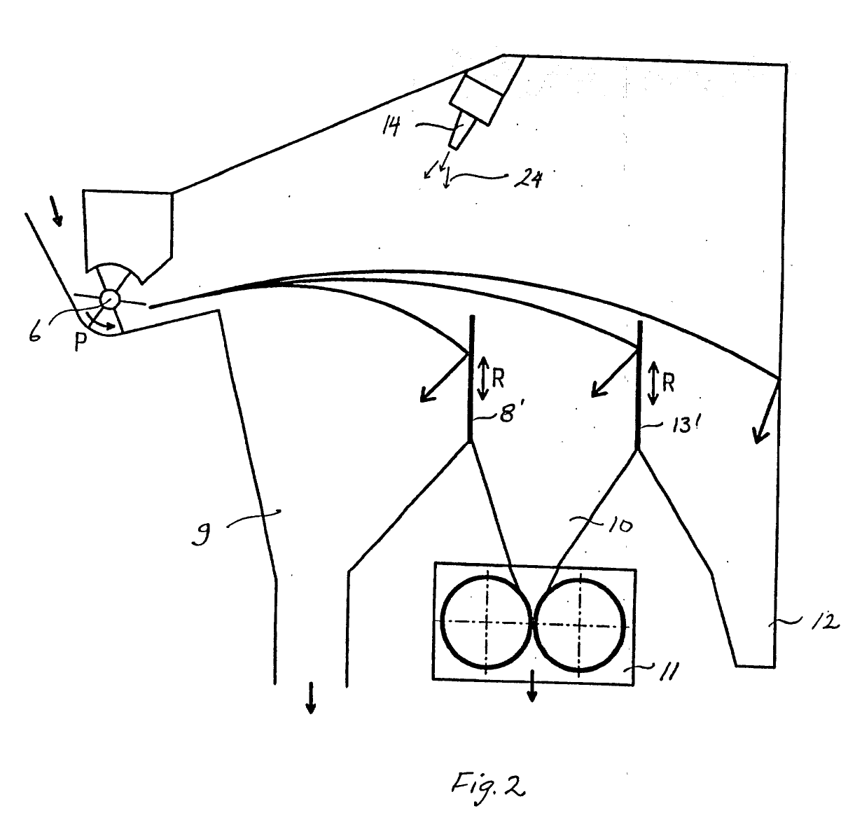

FIG. 2 shows alternative separating flaps usable in a screening method according to the invention,

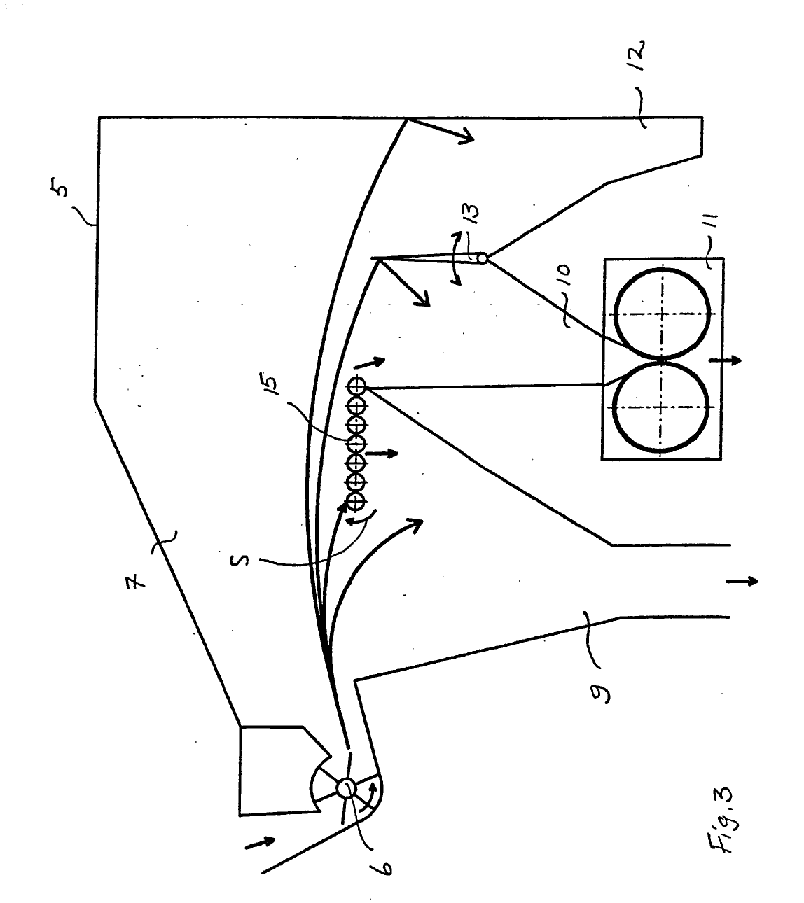

FIG. 3 shows a screening method supplemented with a roll screen,

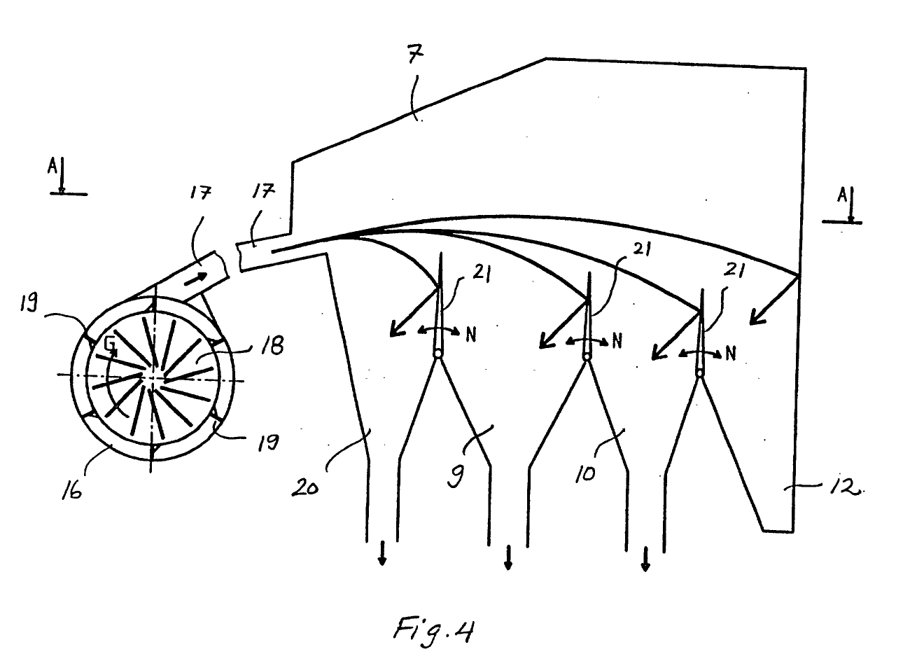

FIG. 4 shows another feeding method usable in a screening method according to the invention,

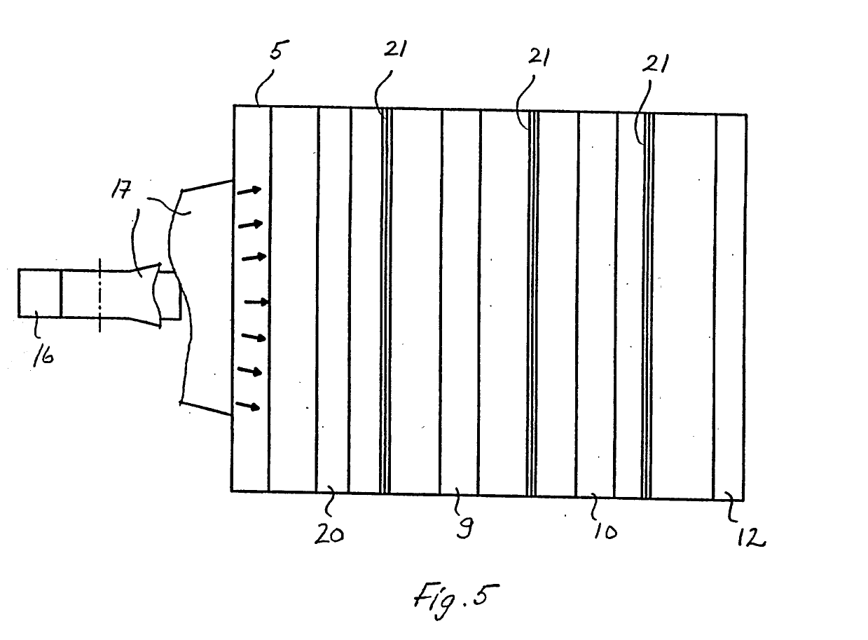

FIG. 5 shows section A-A of FIG. 4,

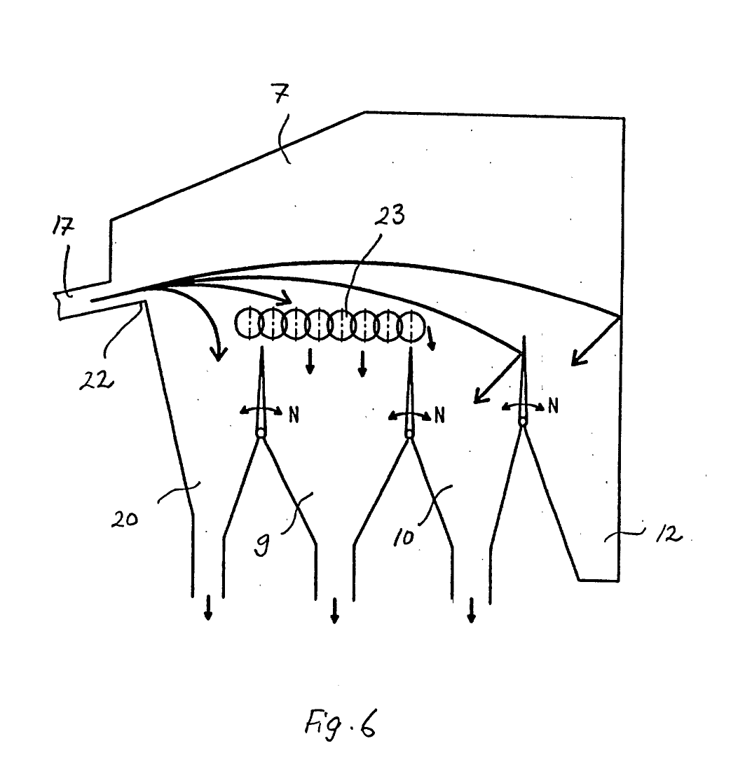

FIG. 6 shows the screening method according to FIG. 4 supplemented with a disc screen, and

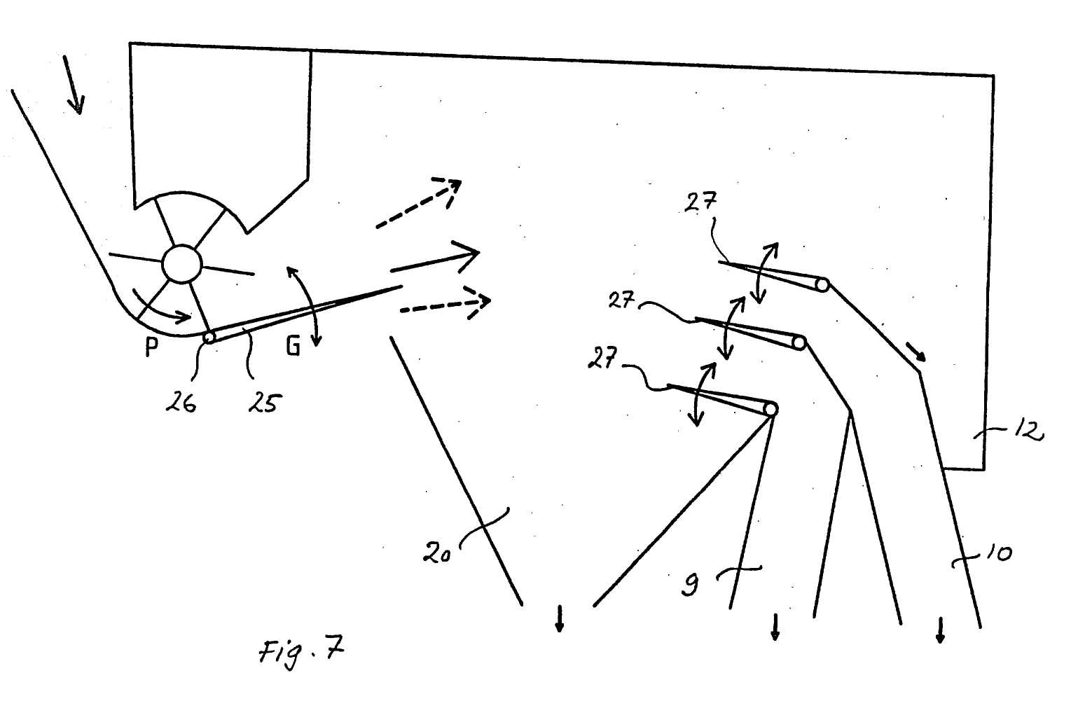

FIG. 7 shows another embodiment of the separating flaps.

In FIG. 1, a flat screen 1 sorts the chips into three fractions: into sawdust 2, medium-sized fraction 3 and oversized fraction 4. The sawdust 2 is usually burned together with the bark. The oversized fraction 4 is led to a separate treatment, e.g. to a rechipper. The chips chipped by the rechipper are transported back to the flat screen 1. The middle-sized fraction 3 produced by the flat screen falls down to the ejection rotor 6 of an ejection sorter 5. The rotor rotates in the direction of arrow P and at such a speed that the chips get sufficient kinetic energy to be able to fly into a chip separation chamber 7. The treatment of chips succeeds only if the ejection rotor 6 is wide enough in relation to the amount of chips to be treated. By means of the flat screen, the chips can be distributed evenly over the whole width of the ejection rotor.

The speed of rotation of the rotor 6 is adjusted to leave the chips of accepted size and normal density in front of a separating flap 8 in the separation chamber 7, in a funnel 9. Thus, the chips that fall into the funnel 9 constitute the accepted fraction. The densest and heaviest chips fly farthest away, so that they fly over the first separating flap 8 and end up in a funnel 10 located after the first separating flap, and in a finishing device 11. This is due to these chips' greater kinetic energy/air resistance ratio that causes a longer flight curve. By adjusting the angle of the separating flap 8 according to arrow N, and by adjusting the speed of rotation of the rotor 6, an optimal situation is sought under which as great part of the accepted chips as possible falls down in front of the separating flap 8 and under which as great part of the oversized chips and denser chips as possible passes over the separating flap 8. The separation chamber 7 can also be equipped with a third funnel 12 that serves as a scrap trap.

Furthermore, it is possible to equip the scrap trap 12 with an adjustable separating flap 13, placed. in front of the scrap trap. The scrap trap receives all pieces denser than wood, i.e. stones, iron pieces and, possibly, even the heaviest knots that the chips are not to include. In FIGS. 1-6 the arrows stand for the flight paths of the chips.

A current of air 24 can be blown from above by means of nozzles 14 into the chip flow flying from the rotor 6 so as to make the chips separate from each other more effectively. As the current of air presses the chips downward and as the air resistance increases, the length of the separation area can be reduced. The nozzles can also be placed on the sides or at the back of the chamber so as to increase the air resistance. In this case the current of air can be perpendicular to or diagonal in relation to the flight path of the chips.

In FIG. 2, separating flaps 8′ and 13′ are, instead of having an adjustable angle, vertically adjustable according to arrow R.

In FIG. 3, a roll screen 15 is used instead of a separating flap 8 to free the accepted chips of chip pieces of big size which, however, do not fly far because of their great air resistance. The accepted chips that fall onto the roll screen fall through the spaces between the rolls and end up in the funnel 9, among the accepted chips. The roll screen transports too big or too thick chips on its surface to the funnel 10. The rolls roll in the direction of arrow S. Instead of a roll screen any corresponding device, such as a disc screen or the like can be used.

Instead of a flat screen, other pre-screening methods, i.e. roll, disc or bar screening can also be used resulting in an even layer of chips over the whole width of the ejection rotor. If no pre-screening is used, the chip layer can be distributed to the ejection rotor by means of a transversal screw conveyor or by means of a fan conveyor.

In FIG. 4, blowing is used instead of an ejection rotor. The blowing is generated by a blowing chipper 16 whose blowpipe 17 is directly connected to the separation chamber 7. The disc 18 of the blowing chipper rotates in the direction of the arrow G. The outer periphery of the disc is provided with wings 19 that generate a strong current of air in the blow pipe 17. The centrifugal force moves also the chips to the outer periphery of the chipper. Furthermore, the wings and the air current make the chips fly into the separation chamber 7 along the blowpipe 17 as a result of which no separate conveyors are needed between the chipper and the screening process. As is shown in FIG. 5, the blowpipe 17 becomes wider in proximity to the separation chamber 7 so that the chip flow can be distributed over the whole width of the separation chamber according to the arrows shown in FIG. 5. Because no pre-screening is used, even the sawdust is separated in the separation chamber 7. The sawdust falls into a first funnel 20. The accepted fraction falls into the funnel 9, while too big and too thick chips fall into the funnel 10. Besides, it is possible to collect the pieces heavier than wood in a fourth funnel, i.e. in the scrap trap 12. Adjustable flaps 21 are provided between the funnels.

The ejection of the chips into the separation chamber can also be performed by means of a fan conveyor, belt conveyor or by means of a chip conveyor of another type.

The treatment of the chips led into the funnel 10 of the separation chamber 7, which funnel is intended for too big and too thick chips, can be finished, for example, by means of a rechipper, sliver chipper, chip cutting machine or chip flattener 11 as is shown in FIGS. 1, 2 and 3.

When no pre-screening is used, very long or filamentous chips produced by the chipper may not fly very far in the separation chamber 7 because of their extensive surface area. In FIG. 6, a method for the removal of filamentous chips is shown. A disc screen 23 covers a part of the distance, or the whole distance between the mouth of the blowpipe 22 and the funnel 10 of the oversized chips. The disc screen 23 transports the long chips on its surface into the funnel 10 and lets through the sawdust and the accepted chips.

One method for finding a suitable separation ratio for the different kinds of chips, for example, is to make the ejection ramp 25 pivotable. As is shown in FIG. 7, the ejection ramp can be turned on its pivot 26 according to arrow G. The initial direction of the flight path of the chips can be changed in the vertical direction by changing the angle of the ejection ramp.

The separating flaps 27 can also be spaced apart in the vertical direction, as is shown in FIG. 7, so that the flaps 27 are horizontal or almost horizontal. The heaviest pieces fly over the topmost flap, while the sawdust falls down underneath the lowermost flap. Thus, the funnels of the different chip sorts are placed, for example, in the same order as in FIG. 4.

1. A method for the sorting of chips in which method pieces provided with kinetic energy are separated from each other on the basis of the form or the length of their flight curve depending on their air resistance and are collected into different fractions by means of collecting devices (9, 10, 12, 20) located at different positions, into which the pieces having different flight curves fly, characterised in that chips (3) are sorted whose kinetic energy is generated by a mechanical device (6) which sets the chips into free flight, or by means of a fan conveyor or by means of the blow wings (19) of a blowing chipper (16).

2. A sorting method as defined in claim 1, characterised in that an ejection rotator (6) is used as the mechanical device and in that the flying speed of the chips (3) ejected by the rotator is adjusted by adjusting the speed of rotation of the ejection rotor.

3. A sorting method as defined in claim 1, characterised in that the separation of the chips (3) from each other, ejected by the ejection rotor (6), is adjusted by means of flaps (8, 13, 21) which are located in a separation chamber (7) and which can be turned around their substantially horizontal pivots, or which are movable substantially in the vertical direction, and by means of which the distance of the front edge and/or the far edge of a given funnel (9, 10, 12, 20), serving as a collecting device, from the ejection rotor (6) is adjusted.

4. A screening method as defined in claim 1, characterised in that that the length of the flight path of the chips (3) ejected by the ejection rotor (6) is reduced and adjusted by means of an air blast (24) which is directed toward the chips, perpendicularly or diagonally toward their flight path, or directly against the direction of flight path.

5. A sorting method as defined in claim 1, characterised in that the chips which have fallen in the separation chamber (7) into a funnel of oversized or too thick chips (10) are treated by means of a chip flattener, rechipper, sliver chipper or chip cutting machine (11).

6. A sorting method as defined in claim 1, characterised in that pieces heavier than wood are collected in the last funnel (12) of the separation chamber (7), which funnel serves as a scrap trap.

7. A sorting method as defined in claim 1, characterised in that the separation of the chips (3) from each other is made more effective in the separation chamber (7) by using a roll screen (15) or a disc screen (23).

8. A sorting method as defined in claim 2, characterised in that the chips are distributed over the whole width of the ejection rotor (6) by means of a flat screen, roll screen, disc screen or bar screen (1) which removes sawdust (2) and oversized chips (4), or by means of a transversal screw conveyor or a fan conveyor.

9. An apparatus for the sorting of chips, including means for setting pieces into motion in a direction having a horizontal component, and at least two collecting devices (9, 10, 12, 20) located at different positions, characterised in that the means for setting pieces into motion is a mechanical device (6) which ejects the chips (3).

10. An apparatus as defined in claim 9, characterised in that the mechanical ejecting device is an ejection rotor (6) or a belt conveyor.

11. An apparatus as defined in claim 9 or 10, characterised in that the mechanical ejecting device (6) is equipped with a pivotable ejection ramp (25) so as to give the flight path of the chips (3) a certain initial direction.

12. An apparatus as defined in claim 11, characterised in that the ejection ramp (25) is so inclined that the first part of the flight path of the chips (3) is ascending.

13. An apparatus for the sorting of pieces, including means for setting the pieces into motion in a direction having a horizontal component, and at least two collecting devices (9, 10, 12, 20) located at different positions, characterised in that the means for setting the pieces into motion is a fan conveyor or a blowing chipper (16) which blows chips (3).

14. An apparatus as defined in claim 9 or 13, characterised in that the mouths of the collecting devices (9, 10, 12, 20) are located at different heights.

15. An apparatus as defined in claiml3, characterised in that a blow pipe (17) for the chips blown out from the chipper (16) becomes wider before it joins a separation chamber (7).

16. An apparatus as defined in claim 9 or 13, characterised in that a roll screen (15) or a disc screen (23) covers a part of the distance, or the whole distance between the end of the ejection ramp (25) or the mouth of the blow pipe (22) and the funnel of the oversized chips (10).

17. The use of an apparatus, which is designed for the sorting of pieces having kinetic energy, on the basis of the form or the length of their flight curve which depends on their air resistance, and which apparatus includes means for setting the pieces into motion in a direction having a horizontal component, and at least two collecting devices (9, 10, 12, 20) which are located at different positions and into which the pieces having different flight paths fly, characterised in that the apparatus is used for the sorting of chips (3).
